(19) United States
(12) Patent Application Publication
(10) Pub. No.: US 2024/0329305 A1
(43) Pub. Date: Oct. 3, 2024

(54) OPTICAL WAVEGUIDE DEVICE AND MANUFACTURING METHOD THEREOF

(71) Applicant: SHINKO ELECTRIC INDUSTRIES CO., LTD., Nagano (JP)

(72) Inventors: Kazunao YAMAMOTO, Nagano (JP); Hisashi KANEDA, Nagano (JP)

(21) Appl. No.: 18/616,894

(22) Filed: Mar. 26, 2024

(30) Foreign Application Priority Data
Mar. 29, 2023 (JP) 2023-052665

(51) Int. Cl. G02B 6/122

(52) U.S. Cl. CPC G02B 6/122

(57) ABSTRACT

An optical waveguide device includes a substrate, a first cladding layer disposed on the substrate, a core layer disposed on the first cladding layer, and a recess formed in the core layer along a longitudinal direction of the core layer and opened on a first surface of the core layer facing away from the first cladding layer.

### CROSS-REFERENCE TO RELATED APPLICATIONS

The present application is based on and claims priority to Japanese Patent Application No. 2023-052665 filed on Mar. 29, 2023, with the Japanese Patent Office, the entire contents of which are incorporated herein by reference.

### FIELD

The disclosures herein relate to optical waveguide devices and manufacturing methods thereof.

### BACKGROUND

An optical waveguide device having silicon photonic chips and optical waveguides is used to transmit and receive signals in a data center where various computers and data communication apparatuses are installed. In such an optical waveguide device, the core layer of an optical waveguide and the silicon waveguide of a silicon photonic chip are optically coupled to each other.

In the optical waveguide device as described above, difficulty arises in aligning the core layer of the optical waveguide with the silicon waveguide of the silicon photonic chip, which may result in a failure to provide sufficient positional accuracy.

There may be a need for an optical waveguide device capable of improving the positional accuracy of a silicon waveguide relative to a core layer.

### RELATED ART LITERATURE

### [Patent Document]

[Patent Document 1] U.S. Pat. No. 6,909,637

### SUMMARY

According to at least one embodiment, an optical waveguide device includes a substrate, a first cladding layer disposed on the substrate, a core layer disposed on the first cladding layer, and a recess formed in the core layer along a longitudinal direction of the core layer and opened on a first surface of the core layer facing away from the first cladding layer.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIGS. 1A and 1B are drawings illustrating an example of an optical waveguide device according to a first embodiment;

FIGS. 2A and 2B are drawings illustrating the example of the optical waveguide device according to the first embodiment;

FIG. 3 is a drawing illustrating an example of a manufacturing process of the optical waveguide device according to the first embodiment;

FIGS. 4A through 4D are drawings illustrating the example of the manufacturing process of the optical waveguide device according to the first embodiment;

FIG. 5 is a drawing illustrating the example of the manufacturing process of the optical waveguide device according to the first embodiment;

FIGS. 6A and 6B are drawings illustrating the example of the manufacturing process of the optical waveguide device according to the first embodiment;

FIGS. 7A through 7C are drawings illustrating an example of an optical waveguide device according to a second embodiment;

FIGS. 8A and 8B are drawings illustrating an example of a manufacturing process of the optical waveguide device according to the second embodiment;

FIGS. 9A and 9B are drawings illustrating the example of the manufacturing process of the optical waveguide device according to the second embodiment; and

FIGS. 10A and 10B are drawings illustrating an example of an optical waveguide device according to a variation.

### DESCRIPTION OF EMBODIMENTS

In the following, embodiments of the present invention will be described with reference to the accompanying drawings.

In the following, embodiments for carrying out the invention will be described with reference to the accompanying drawings. In these drawings, the same components are referred to by the same reference numerals, and duplicate descriptions thereof may be omitted.

### First Embodiment

### [Optical Waveguide Device]

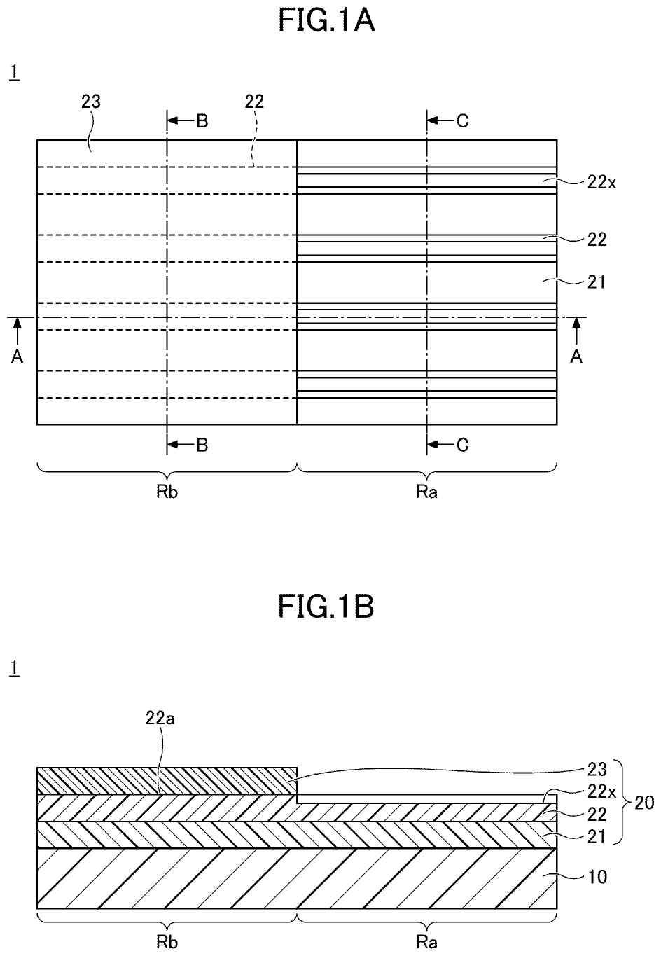

FIGS. 1A and 1B are drawings illustrating an example of an optical waveguide device according to a first embodiment. FIG. 1A is a plan view, and FIG. 1B is a cross-sectional view taken along the line A-A in FIG. 1A.

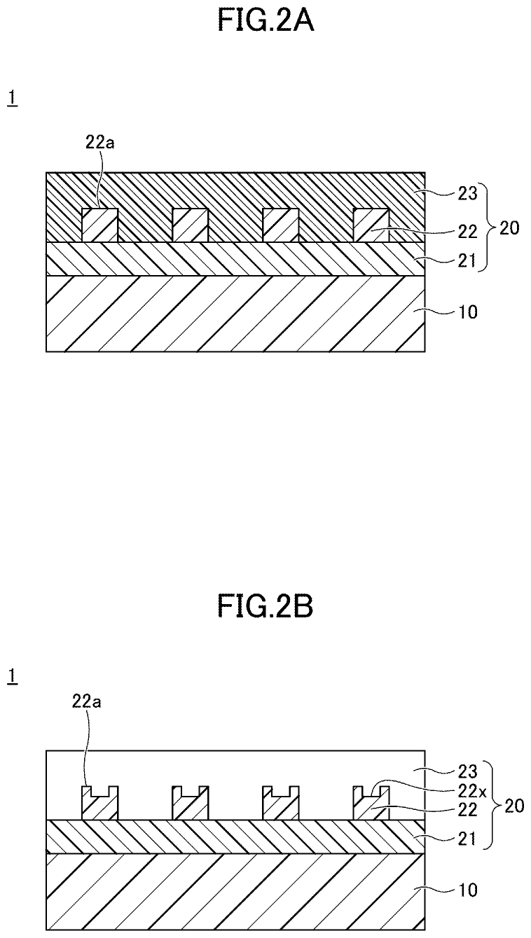

FIGS. 2A and 2B are drawings illustrating the example of the optical waveguide device according to the first embodiment, FIG. 2A is a cross-sectional view taken along the line B-B in FIG. 1A, and FIG. 2B is a cross-sectional view taken along the line C-C in FIG. 1A.

Referring to FIGS. 1A and 1B, an optical waveguide device 1 includes a substrate 10 and an optical waveguide 20. The optical waveguide 20 includes a first cladding layer 21, a core layer 22, a recess 22x, and a second cladding layer 23.

The substrate 10 serves as a base on which the first cladding layer 21, the core layer 22, and the second cladding layer 23 are formed. The substrate 10 is made of an insulating resin material such as glass epoxy resin, for example. The substrate 10 may be a rigid substrate with strong rigidity or a flexible substrate with weak rigidity. The substrate 10 includes an insulating material referred to as a support or a base material. The substrate 10 may be, for example, a ceramic substrate, a silicon substrate, a build-up substrate having a resin layer. An electrical circuit may be formed on the substrate 10.

The first cladding layer 21 is formed on the substrate 10. The thickness of the first cladding layer 21 may be, for example, about 10 μm to 30 μm. The refractive index of the first cladding layer 21 may be, for example, about 1.5. The first cladding layer 21 may be made of a photosensitive resin such as a polyimide resin, an acrylic resin, an epoxy resin, a polyolefin resin, a polynorbornene resin, or the like.

The core layer 22 is formed on the first cladding layer 21. The width of each strip of the core layer 22 may be, for example, about 5 μm to 10 μm. The thickness of the core layer 22 may be, for example, about 5 μm to 10 μm. The refractive index of the core layer 22 is higher than the refractive indexes of the first cladding layer 21 and the second cladding layer 23, and may be, for example, about 1.6. The core layer 22 may be made of, for example, a material selected as appropriate from the materials listed as examples of the first cladding layer 21.

In the optical waveguide device 1, four strips of the core layers 22 are arranged side by side at predetermined intervals. This arrangement is a non-limiting example, and the number of strips of the core layers 22 may be any number that is one or more. A strip of the core layer 22 may not need to be formed in a straight line, may have a curved portion.

The core layer 22 has a first region Ra in which a recess 22x is provided, and a second region Rb in which a recess 22x is not provided. The first region Ra may be used as a section for optical coupling with a silicon waveguide or the like. In the first region Ra, the recess 22x is provided along the longitudinal direction of each strip of the core layer 22, and is open on the first surface 22a located on the opposite side of the core layer 22 from the first cladding layer 21.

The recess 22x is provided, for example, along the centerline extending in the longitudinal direction and dividing a strip of the core layer 22 into halves when viewed from the direction perpendicular to the first surface 22a. The line A-A in FIG. 1A is drawn on the centerline extending in the longitudinal direction and dividing a strip of the core layer 22 into halves. The width of the recess 22x may be, for example, about 1.5 μm to 2.5 μm on the same plane as the first surface 22a. The maximum depth of the recess 22x may be, for example, about 0.5 μm to 1.5 μm as measured from the first surface 22a.

The bottom surface of the recess 22x may or may not be parallel to the first surface 22a. The side surfaces of the recess 22x may or may not be perpendicular to the first surface 22a. The recess 22x may, for example, have a shape that narrows in width toward the bottom surface from the first surface 22a. The boundary between the bottom surface and the side surfaces of the recess 22x may not be clear. For example, the transition between the bottom surface and the side surfaces of the recess 22x may have a rounded shape.

The second cladding layer 23 is provided on the first cladding layer 21, and covers only the second region 22b of the core layer 22, leaving the first region Ra of the core layer 22 exposed. That is, the recess 22x is exposed from the second cladding layer 23. The thickness of the second cladding layer 23 may be, for example, about 10 μm to 30 μm. The refractive index of the second cladding layer 23 may be, for example, about 1.5. The second cladding layer is a cured photosensitive resin. The second cladding layer 23 may be made of, for example, a material selected as appropriate from the examples listed as the material of the first cladding layer 21.

### [Method of Making Optical Waveguide Device]

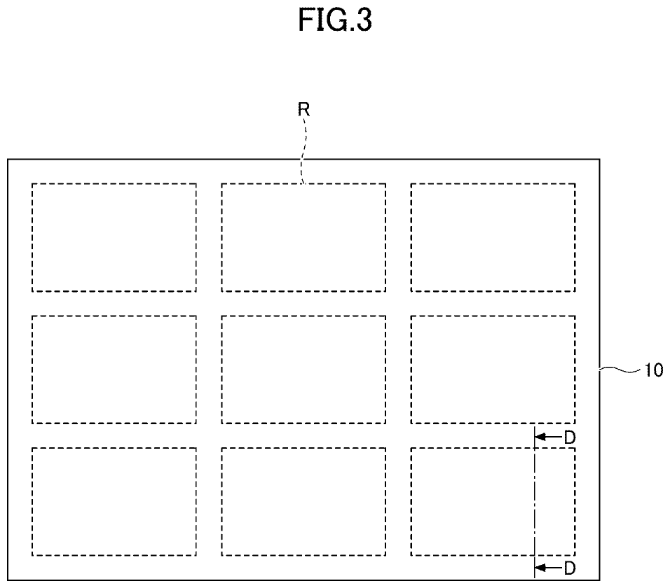

In the following, a method of making the optical waveguide device 1 will be described. FIG. 3 through FIGS. 6A and 6B illustrate an example of a manufacturing process of the optical waveguide device according to the first embodiment.

In the method of making the optical waveguide device according to the first embodiment, a substrate 10 is first prepared as illustrated in FIG. 3. The substrate 10 is, for example, a large substrate for providing multiple devices in which a plurality of product regions R are partitioned, and will be cut along the outer perimeter of each of the product regions R to obtain individual optical waveguide devices. The substrate 10 is made of an insulating resin material such as, for example, a glass epoxy resin. The substrate 10 may be a rigid substrate with strong rigidity or a flexible substrate with weak rigidity. The substrate 10 includes an insulating material referred to as a support or a base material.

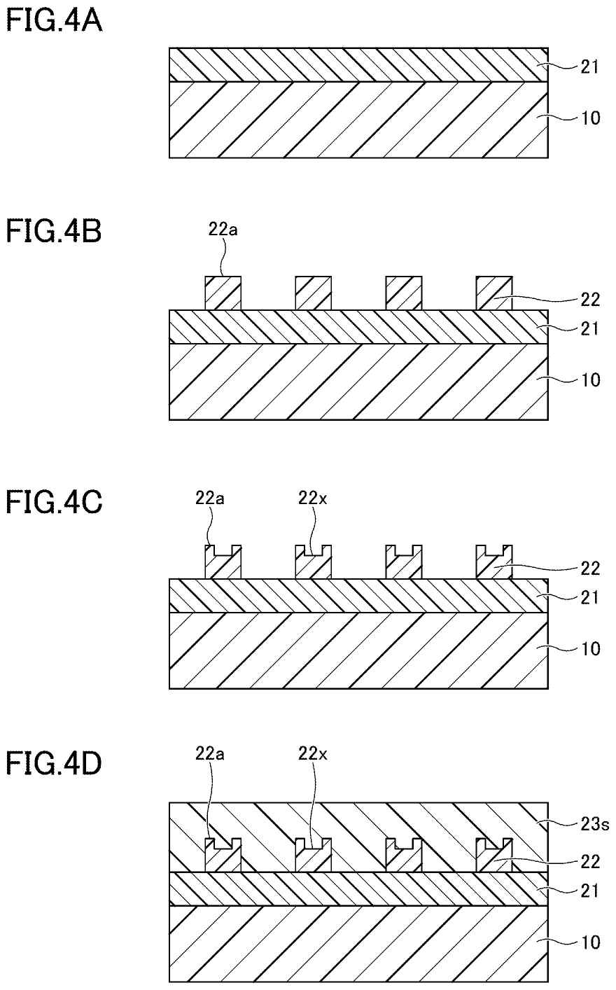

FIG. 4A illustrates a cross section taken along the line D-D in FIG. 3. In the step illustrated in FIG. 4A, a first cladding layer 21 is formed on the substrate 10. The first cladding layer 21 is made by irradiating a photosensitive resin with ultraviolet light and then curing the photosensitive resin by heat treatment at a temperature of 150° C. to 200° C.

The first cladding layer 21 is formed on the entire surface of the substrate 10 on which the plurality of product regions R illustrated in FIG. 3 are provided. When there is a need to adjust the outer shape of the first cladding layer 21 by patterning, the photosensitive resin is irradiated with ultraviolet light through a photomask and developed to produce the first cladding layer 21.

The method of forming the photosensitive resin may include attaching a resin sheet or applying a liquid resin. The thickness of the first cladding layer 21 is, for example, about 10 μm to 30 μm.

In the step illustrated in FIG. 4B, strips of a core layer 22 arranged side by side are formed on the first cladding layer 21. Specifically, a photosensitive resin for creating the core layer 22 is disposed on the first cladding layer 21, and the photosensitive resin is irradiated with ultraviolet light through a photomask and developed, followed by curing the photosensitive resin by heat treatment at a temperature of about 150° C. to 200° C.

With this arrangement, the strips of the core layer 22 each having a band shape are arranged side by side on the first cladding layer 21. The width of each stripe of the core layer 22 is set to, for example, 5 μm to 10 μm, and the thickness of the core layer 22 is set to, for example, 5 μm to 10 μm. In this embodiment, each strip of the core layer 22 has a small cross-sectional area in order to provide a single-mode optical waveguide.

The strips of the core layer 22 extend laterally in above-noted FIG. 3 in such a manner as to extend through the product regions R and across gaps between the product regions R.

In the step illustrated in FIG. 4C, a recess 22x opening on the first surface 22a of the core layer 22 is formed along the longitudinal direction of each stripe of the core layer 22. The recess 22x may be formed by laser processing or etching, for example. In the case of laser processing, an excimer laser, for example, may be used.

In the step illustrated in FIG. 4D, a photosensitive resin 23s for creating a second cladding layer 23 is disposed on the first cladding layer 21 and the core layer 22. The photosensitive resin 23s is structured to have a flat upper surface while covering the upper surfaces and the side surfaces of the core layer 22 and filling the recesses 22x.

As the photosensitive resin 23s, for example, a negative photosensitive epoxy resin or polyimide resin may be used. Substantially the same photosensitive resin is used for the first cladding layer 21 and the core layer 22 previously described.

The photosensitive resin 23s includes a reactive functional group contributing to photocuring and a reactive functional group contributing to thermosetting, and is cured by photocuring and thermosetting.

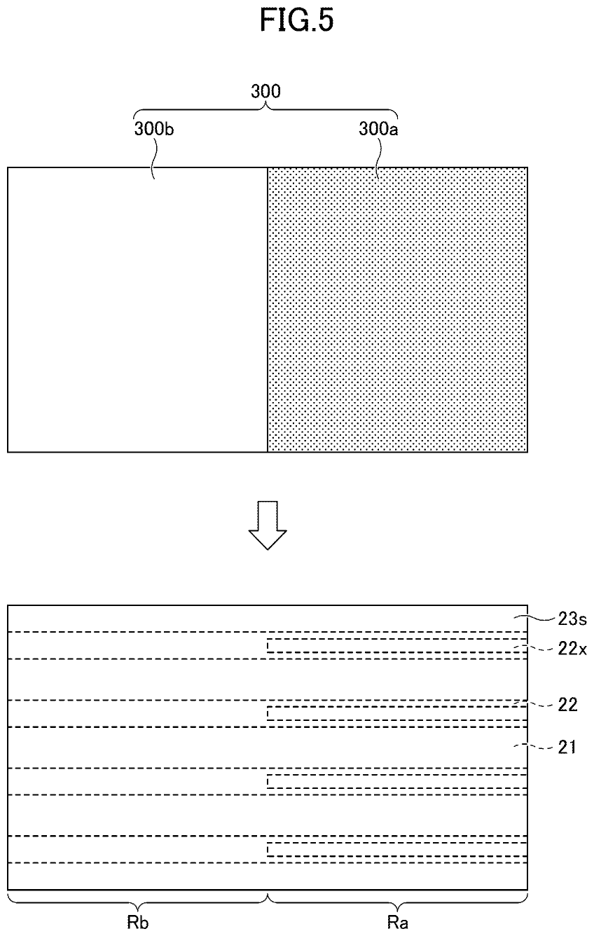

In a next step as illustrated in FIG. 5, a photomask 300 is prepared and placed on the photosensitive resin 23s. FIG. 5 is a partial view illustrating a portion of the photomask 300 corresponding to one product region R in FIG. 3 previously described. The photomask 300 includes a light shielding part 300a and a light transmitting part 300b.

The light shielding part 300a of the photomask 300 is positioned to align with the region Ra that is the part of each product region R of FIG. 3 in which the recesses 22x are formed, and is used to cause the photosensitive resin 23s arranged in the region Ra to become an uncured part without being exposed.

The light transmitting part 300b of the photomask 300 is positioned to align with the region Rb that is the part of each product region R of FIG. 3 in which the recesses 22x are not formed, and is used to cause the photosensitive resin 23s disposed in the region Rb to form a cured portion upon being exposed.

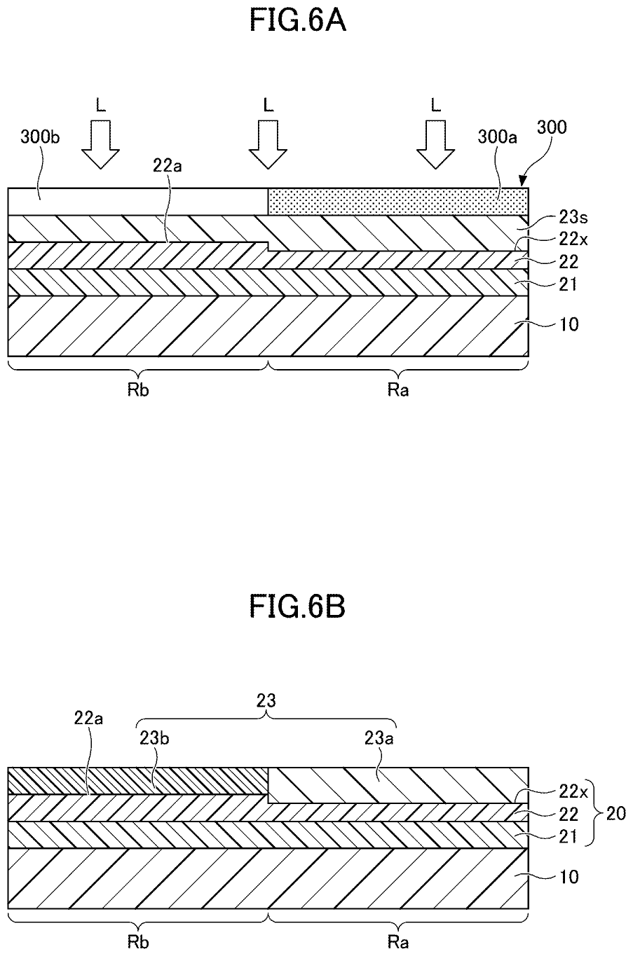

In the steps illustrated in FIGS. 6A and 6B, ultraviolet light L is directed onto the photosensitive resin 23s through the photomask 300 to partially cure the photosensitive resin 23s. In FIG. 6A, the photosensitive resin 23s in the region Rb of each product region R is exposed to ultraviolet light L through the light transmitting part 300b of the photomask 300, which results in the photosensitive resin 23s in the region Rb of each product region R being cured. While this happens, the photosensitive resin 23s in the region Ra of each product region R is shielded from light by the light shielding part 300a of the photomask 300, and is thus left in an uncured state without being exposed.

At this point, the exposed photosensitive resin 23s is not treated with a developer, and the unexposed portion of the photosensitive resin 23s in the region Ra of each product region R is left as the uncured portion.

Subsequently, a heat treatment (post-bake) is performed at a temperature of 150° C. to 200° C. As a result, the second cladding layer 23 is formed on the first cladding layer 21 and the core layer 22. The thickness of the second cladding layer 23 is, for example, about 10 μm to 30 μm.

The photomask 300 is then removed. As illustrated in FIG. 6B, the uncured portion 23a of the second cladding layer 23 is disposed in the region Ra of each product region R. In each product region R, the recesses 22x of the strips of the core layer 22 are filled with the uncured portion 23a of the second cladding layer 23. In addition, the cured portion 23b of the second cladding layer 23 is arranged in the region Rb of each product region R.

The cured portion 23b of the second cladding layer 23 is obtained by completely curing the photosensitive resin 23s by light curing and thermal curing. The uncured portion 23a of the second cladding layer 23 is formed of the photosensitive resin 23s that has undergone only heat treatment at a temperature of 150° C. to 200° C. without being exposed, and is thus maintained in an uncured state. The uncured portion 23a and the cured portion 23b of the second cladding layer 23 are continuous with each other.

In this manner, the optical waveguide 20 is structured with the first cladding layer 21, the core layer 22 formed on the first cladding layer 21, and the second cladding layer 23 formed on the first cladding layer 21 and the core layer 22.

In the optical waveguide 20, the refractive index of the core layer 22 is set to be higher than the refractive indexes of the first cladding layer 21 and the second cladding layer 23.

In the present embodiment, the uncured portion 23a and the cured portion 23b of the second cladding layer 23 are formed of the photosensitive resin 23s which is a negative photosensitive resin.

Alternatively, the uncured portion 23a and the cured portion 23b of the second cladding layer 23 may be formed of a positive photosensitive resin.

In the case of a negative type, an exposed portion irradiated with light changes from soluble to insoluble by a cross-linking reaction, and an unexposed portion (uncured portion) is removed by a developer, leaving the exposed portion as a cured portion.

In contrast, in the case of a positive type, an exposed portion (uncured portion) irradiated with light changes chemically from an alkali insoluble part to a soluble part, and is removed by a developer, leaving an unexposed portion as a cured portion.

When a positive photosensitive resin is used, a positive photomask is used, which is made by inverting the black and white of the negative photomask illustrated in FIG. 5. A positive photosensitive resin is exposed through the positive photomask.

With such an arrangement, the exposed portion of the positive photosensitive resin becomes the uncured portion 23a of the second cladding layer 23 that is dissolved by a developer. The unexposed portion of the positive photosensitive resin is thermally cured to become the cured portion 23b of the second cladding layer 23.

As described above, the second cladding layer 23 may be formed of a negative photosensitive resin (i.e., photosensitive resin 23s) or a positive photosensitive resin. The uncured portion 23a of the second cladding layer 23 has a property of being dissolvable in a negative or positive developer to be removed. On the other hand, the cured portion 23b of the second cladding layer 23 has a property of being not dissolvable in a negative or positive developer.

Along the outer perimeter of each product region R, the second cladding layer 23, the core layer 22, the first cladding layer 21, and the substrate 10 are cut by a rotary blade or the like of a cutting device, which produces individual pieces.

At this time, the region having the recesses 22x of the core layer 22 formed therein is covered with, and protected by, the uncured portion 23a of the second cladding layer 23. Because of this, when the core layer 22 is cut, the region having the recesses 22x of the core layer 22 formed therein is at no risk of being damaged, which enables the reliable cutting of the core layer 22. There is also no risk that the core layer 22 is contaminated with sawdust.

As a result, the end faces of the second cladding layer 23, the core layer 22, the first cladding layer 21, and the substrate 10 in a direction of extension of the strips of the core layer 22 are formed of cut faces, and are flush with each other.

Subsequently, by treating the second cladding layer 23 with a developer, the uncured portion 23a of the second cladding layer 23 is removed, and the region Ra in which the recesses 22x of the core layer 22 are formed is exposed from the second cladding layer 23. In this manner, the optical waveguide device 1 illustrated in FIGS. 1A and 1B and FIGS. 2A and 2B is completed in final form.

When the second cladding layer 23 is formed of a negative photosensitive resin, the uncured portion 23a of the second cladding layer 23 may be dissolved by a negative developer for removal. When the second cladding layer 23 is formed of a positive photosensitive resin, the uncured portion 23a of the second cladding layer 23 may be dissolved by a positive developer for removal.

The uncured portion 23a of the second cladding layer 23 may be left unremoved when the product is shipped from the factory. In this case, the optical waveguide device 1 has the second cladding layer 23 formed on the first cladding layer 21. The structure is such that the second cladding layer 23 includes the uncured portion 23a, which is an uncured photosensitive resin covering the first region Ra of the core layer 22, and includes the cured portion 23b, which is a cured photosensitive resin covering the second region Rb of the core layer 22. Since the uncured portion 23a made of an uncured photosensitive resin has a property of being dissolvable and removable by a developer, the recesses 22x of the core layer 22 may be exposed from the second cladding layer 23 by treating the uncured portion 23a with a developer at any stage as desired by a person who has obtained the product.

### Second Embodiment

The second embodiment is directed to an example of an optical waveguide device optically coupled with a silicon waveguide. In the second embodiment, a description of the same components as in the previously described embodiment may be omitted.

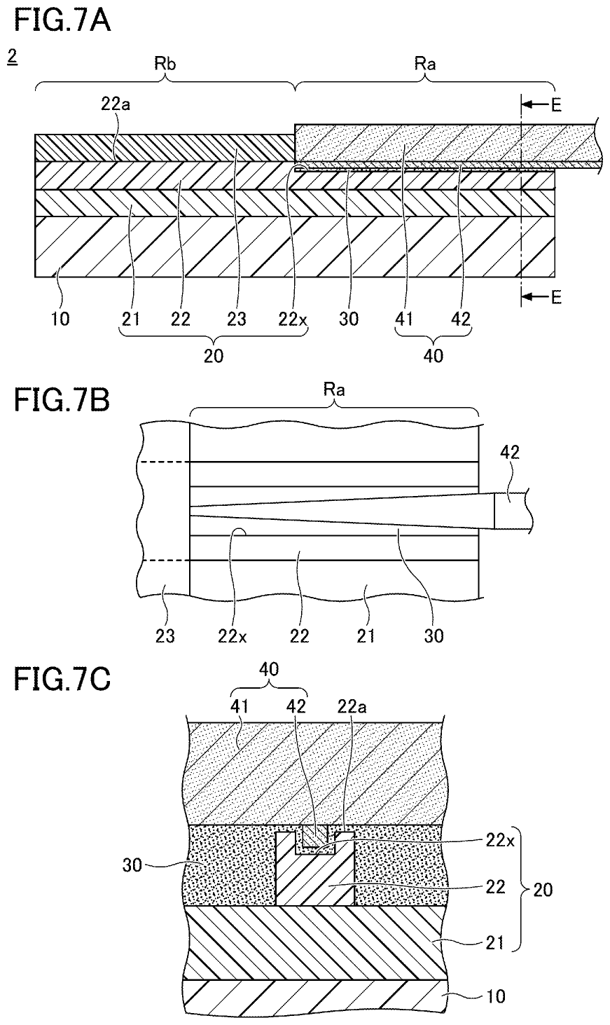

FIGS. 7A through 7C are drawings illustrating an example of an optical waveguide device according to the second embodiment. FIG. 7A is a cross-sectional view corresponding to FIG. 1B. FIG. 7B is a partial plan view around the first region Ra in FIG. 7A. FIG. 7C is a partial cross-sectional view along the line E-E in FIG. 7A. In FIG. 7B, a silicon substrate 41 is not illustrated in order to show the positional relationship between the recess 22x and a silicon waveguide 42.

Referring to FIGS. 7A through 7C, the optical waveguide device 2 differs from the optical waveguide device 1 in that an adhesive layer 30 and a silicon photonic chip 40 are additionally provided.

The silicon photonic chip 40 includes a silicon substrate 41 and a silicon waveguide 42 provided on one surface of the silicon substrate 41. The silicon waveguide 42 is a fine optical waveguide incorporated into a silicon chip, and is used in silicon photonic technology for integrating optical circuits and the like in a silicon chip.

The thickness of the silicon substrate 41 is, for example, about 100 μm to 800 μm. The silicon waveguide 42 may, for example, be provided on a protective film disposed on the silicon substrate 41. The protective film may be formed of, for example, SiO₂ or SiO_{X}. The thickness of the protective film is, for example, about 2 μm to 6 μm.

In plan view, one end of the silicon waveguide 42 has a tapered shape. That is, in plan view, one end of the silicon waveguide 42 becomes narrower towards the second cladding layer 23. With such a shape, the optical coupling efficiency between the silicon waveguide 42 and the core layer 22 may be improved. The width of the silicon waveguide 42 is, for example, about 200 nm to 500 nm except for the tapered part. The width of the tip of the tapered part is, for example, about ½ to ¼ of the constant width part. The thickness of the silicon waveguide 42 is constant. The thickness of the silicon waveguide 42 is, for example, about 20 nm to 300 nm.

The silicon photonic chip 40 is mounted on the first cladding layer 21 with the silicon waveguide 42 facing the core layer 22. Part or all of the silicon waveguide 42 is disposed inside the recess 22x. The silicon substrate 41 and the first cladding layer 21 face each other across an adhesive layer 30, which bonds both. The adhesive layer 30 covers the core layer 22. The adhesive layer 30 enters the inside of the recess 22x and covers the silicon waveguide 42.

The structure as noted above ensures that light from the silicon waveguide 42 enters the core layer 22, thereby optically coupling both. Light leaks not only from the bottom surface of the silicon waveguide 42 but also from the side surfaces, so that the arrangement having the silicon waveguide 42 inside the recess 22x enables the improvement of optical coupling efficiency.

In order to improve the optical coupling efficiency, the distance in the height direction between the core layer 22 and the silicon waveguide 42 is preferably 1 μm or less. With the noted structure, the distance in the height direction between the core layer 22 and the silicon waveguide 42 may easily be 1 μm or less.

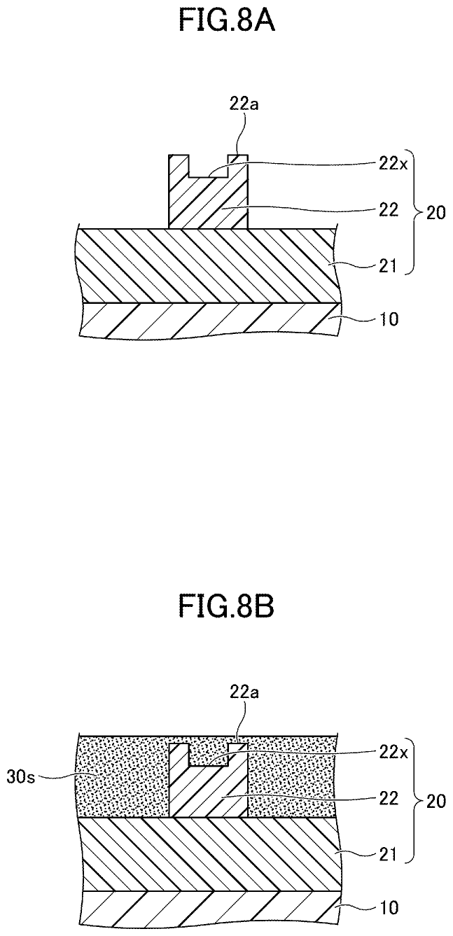

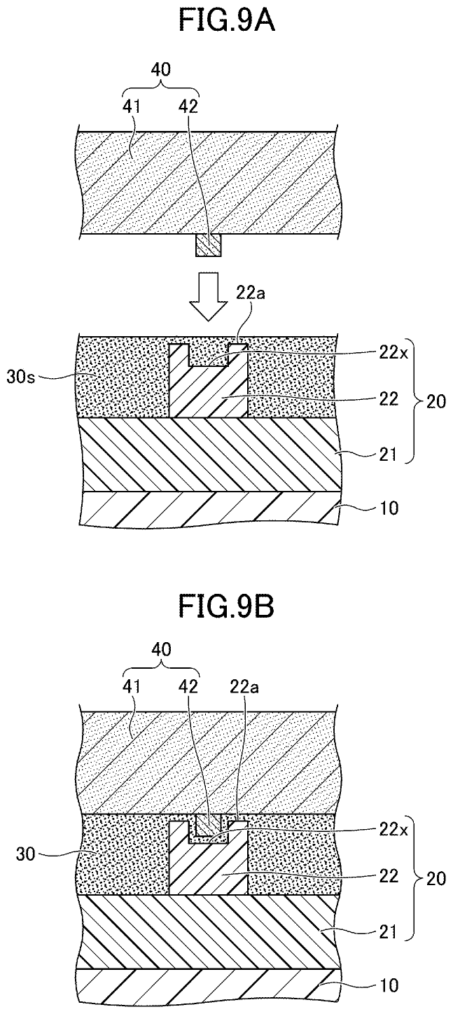

FIGS. 8A and 8B and FIGS. 9A and 9B illustrate an example of a manufacturing process of the optical waveguide device according to the second embodiment. In order to manufacture the optical waveguide device 2, the optical waveguide device 1 described in the first embodiment is prepared in the step illustrated in FIG. 8A. In the step illustrated in FIG. 8B, an uncured resin 30s serving as an adhesive layer 30 is disposed in the first region Ra on the first cladding layer 21 to cover the core layer 22. The resin 30s may be, for example, a photosensitive resin selected as appropriate from the examples listed as materials for the first cladding layer 21.

In the step illustrated in FIG. 9A, a silicon photonic chip 40 is prepared, and is mounted on the first cladding layer 21, with a silicon waveguide 42 facing toward the core layer 22. The arrangement is made such that the recess 22x and the silicon waveguide 42 face each other. For rough alignment of the silicon waveguide 42 and the recess 22x, an alignment method may preferably be used that utilizes an alignment mark used for mounting a semiconductor chip or the like. In the step illustrated in FIG. 9B, the resin 30s is cured by ultraviolet light or the like to form an adhesive layer 30. Through these steps, the optical waveguide device 2 is completed in final form.

In the step illustrated in FIG. 9A, an act of inserting the silicon waveguide 42 serving as a protrusion into the recess 22x enables easy alignment. This arrangement realizes the adiabatically coupled optical waveguide device 2 having excellent positional accuracy between the core layer 22 and the silicon waveguide 42. As described above, due to the provision of the recess 22x in the core layer 22, the optical waveguide device 1 can improve the positional accuracy between the silicon waveguide 42 and the core layer 22 when the silicon photonic chip 40 is mounted on the optical waveguide device 1.

### <Variation>

Variations are directed to examples of an optical waveguide device in which the entire core layer is usable as an optical coupling part. In these variations, a description of the same components as those of the previously described embodiments may be omitted.

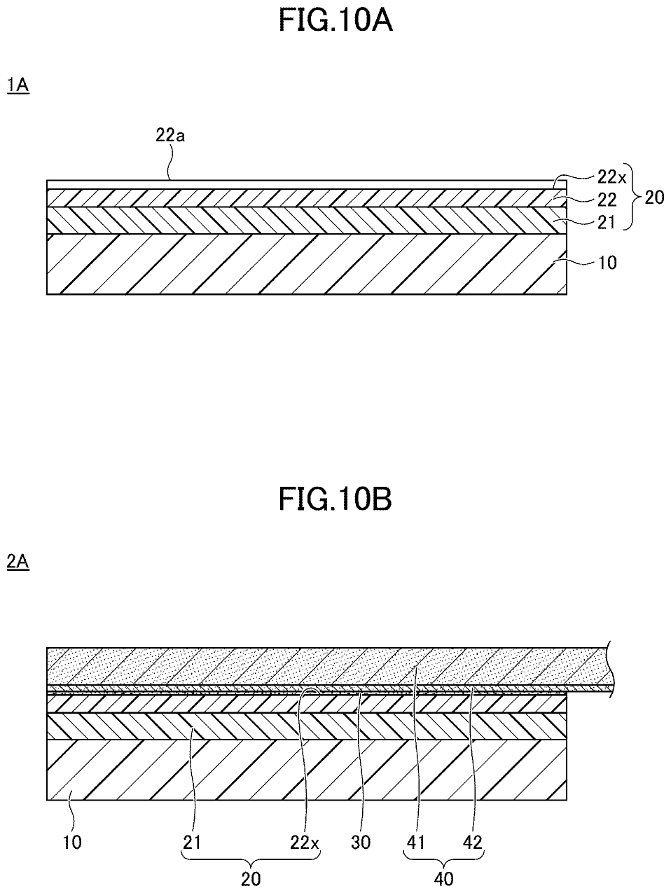

FIGS. 10A and 10B are drawings illustrating examples of an optical waveguide device according to variations. FIG. 10A is a cross-sectional view illustrating an optical waveguide device 1A according to a variation of the first embodiment, and is a cross-sectional view corresponding to FIG. 1B.

The optical waveguide device 1A does not have a second cladding layer 23, and the recesses 22x are provided in the entire longitudinal direction of the strips of the core layer 22. That is, the entire optical waveguide device 1A has the same structure as the first region Ra of the optical waveguide device 1A. With such a structure, the entire core layer 22 is usable as an optical coupling part.

FIG. 10B is a cross-sectional view illustrating an optical waveguide device 2A according to a variation of the second embodiment, and is a cross-sectional view corresponding to FIG. 7A.

In the optical waveguide device 2A, the silicon photonic chip 40 is mounted, with the silicon waveguide 42 facing the core layer 22, on the first cladding layer 21 of the optical waveguide device 1A through the adhesive layer 30. In the optical waveguide device 2A, light leaking from the silicon waveguide 42 enters the entire core layer 22, which results in both being optically coupled. Such a structure also provides substantially the same advantageous effects as does the second embodiment.

According to the disclosed technique, it is possible to provide an optical waveguide device capable of improving the positional accuracy between a silicon waveguide and a core layer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the changes, various substitutions, and alterations could be made hereto without departing from the spirit and scope of the invention.

The present disclosures non-exhaustively include the subject matter set out in the following clauses:

Clause 1. A method of making an optical waveguide device, comprising:
forming a first cladding layer on a substrate;
forming a core layer on the first cladding layer, and
forming, by laser processing or etching, a recess opening on a first surface of the core layer facing away from the first cladding layer, the recess extending along a longitudinal direction of the core layer.

What is claimed is:

1. An optical waveguide device comprising:
a substrate;
a first cladding layer disposed on the substrate;
a core layer disposed on the first cladding layer; and
a recess formed in the core layer along a longitudinal direction of the core layer and opened on a first surface of the core layer facing away from the first cladding layer.

2. The optical waveguide device as claimed in claim 1, wherein the recess is provided along a centerline extending in the longitudinal direction and dividing the core layer into halves when viewed from a direction perpendicular to the first surface.

3. The optical waveguide device as claimed in claim 1, wherein the core layer has a first region in which the recess is provided and a second region in which the recess is not provided.

4. The optical waveguide device as claimed in claim 3, further comprising a second cladding layer disposed on the first cladding layer, the second cladding layer covering the second region of the core layer and leaving the first region of the core layer exposed,
wherein the second cladding layer is a cured photosensitive resin.

5. The optical waveguide device as claimed in claim 3, further comprising a second cladding layer disposed on the first cladding layer,
wherein the second cladding layer includes both an uncured photosensitive resin covering the first region of the core layer and a cured photosensitive resin covering the second region of the core layer.

6. The optical waveguide device as claimed in claim 5, wherein the uncured photosensitive resin has a property of being dissolvable and removable by a developer.

7. The optical waveguide device as claimed in claim 1, further comprising a silicon photonic chip including a silicon substrate and a silicon waveguide disposed on one side of the silicon substrate,
wherein the silicon photonic chip mounted on the first cladding layer with the silicon waveguide facing toward the core layer, and part or all of the silicon waveguide is disposed inside the recess.

8. The optical waveguide device as claimed in claim 7, further comprising an adhesive layer, wherein the silicon substrate and the first cladding layer face each other across the adhesive layer.

9. The optical waveguide device as claimed in claim 8, wherein the adhesive layer is situated inside the recess and covers the silicon waveguide.
